(19) United States
(12) Patent Application Publication
(10) Pub. No.: US 2011/0148101 A1
(43) Pub. Date: Jun. 23, 2011

(54) COUPLING

(76) Inventor: John Manning, Norwich (GB)

(21) Appl. No.: 12/918,863

(22) PCT Filed: Feb. 20, 2009
(86) PCT No.: PCT/GB09/00478

§ 371 Date: Oct. 27, 2010

(30) Foreign Application Priority Data
Feb. 23, 2008 (GB) 0803299.7

(51) Int. Cl. F16L 25/08

(52) U.S. Cl. 285/308

(57) ABSTRACT

A pipe coupling has a housing has a receiving recess for a pipe, the housing having a through hole extending from a first aperture in an external surface of the housing through to a second aperture in the inner wall of the receiving recess. A fixing element is arranged to slidingly mate with the through hole in the housing to give a mated configuration, and when in the mated configuration, an engagement part of the fixing element is adapted to project through the second aperture to lockingly engage with the outer surface of the pipe. The through note is also provided with a locking means adapted to be configured in an open configuration, in which the fixing element can be slidingly mated with or removed from the through hole through the first aperture, and a locked configuration, in which the locking means holds the fixing element in the mated configuration in the through hole. The pipe coupling provides a fluid-tight connection using relatively low-tolerance, easily manufactured parts and suitable for rapid deployment in hazardous environments.

The present invention relates to a coupling for connecting tubular conduits, in particular for connecting lengths of pipes so as to form a fluid transport system.

Fluid transport systems are known for conveying materials, such as liquids and gasses, with common examples including water and fuels such as gas and oil. The systems may vary from domestic plumbing systems installed in a building to convey water to oil and gas pipelines for conveying fuel over thousands of miles. The tubular conduits used in fluid transport systems may be made of many different materials, including steel, iron, copper, aluminium and plastic.

For smaller diameter pipes, a push fit couplings can be used, for example as described in GB 2,378,993. However, for pipe diameters above around 5 cms, the force required to push the end of a pipe into such a push fit couplings becomes too high for manual connection. In addition, pipes connected by push fit couplings are able to rotate relative to each other, which can cause valve taps to move out of an optimum position. For larger diameter pipes, welded joints can be used. However, welded joints have the disadvantage of requiring skilled workers as well as having negative health and safety and environmental implications. For example, construction of a gas-conveying pipeline, made from 40 metre long lengths of steel pipe and with a 1 metre diameter, conventionally uses welded joints. Each joint can take a skilled team a whole day to make, when taking into consideration, the deployment of equipment at the joint location and inspection of the joint by X-ray equipment. Also, around 1 in 10 of such welded joints will have to be repaired after such an inspection. This makes such pipelines expensive and time consuming to construct. Where plastic pipes are used, heat-fused joints may be used, in which the ends of pipes to be connected are heated up and then fused together. Push fit couplings, welded joints and fused joints are difficult to disconnect, for example for repair or maintenance, with such disconnection often causing damage to the pipes.

One attempt to overcome such problems is by having a series of bolts or screws passing through a housing into the outer wall of the pipe to be coupled. An example of this method is disclosed in U.S. Pat. No. 4,363,405 for application with a lightweight plastic pipe. In order to apply this method to a heavy duty metal pipe, it becomes necessary to use a series of bolts passing through the housing and to press against the outer wall of the pipe, or to engage with holes in the pipe. The bolts have a threaded section that engages with a tapped hole in the outer wall of the housing, and a non-threaded section that extends through the housing and into the wall of the pipe to act as a locating pin. Such a system is found in the Style 167 Lock Coupling for a drilled-end pipe from Dresser Inc. A problem with this arrangement is the number of contact surfaces on the bolt which must be precisely aligned in order to enable the fixing to function whilst providing a fluid-tight seal between the housing and the pipe. In order to tighten into the threaded hole, the bolt must be formed from, a strong material such as steel, and so the locating pin is also of the same material. Also, the system requires a hole to be drilled through the entire wall of the retained pipe, increasing risk of fluid leakage. If the pin does not extend through the wall of the pipe, then the tightening of the bolt onto the outer wall of the pipe may lead to risk of fracture of the pipe. A similar system is also disclosed in GB 966,842, which shows a pipe coupling based on taper-ended connector bolts.

There is a need for a pipe coupling system that overcomes some or all of the disadvantages of the prior art.

Hence, it is one object of the invention, amongst others, to provide a housing assembly for grasping a pipe where a fluid-tight connection may be made using relatively low-tolerance, easily manufactured parts and wherein the connection can be made rapidly in hazardous environments.

A first aspect of the invention provides a coupling having at least one coupling end for connection to a pipe having an outer surface, wherein each coupling end comprises:

a housing defining an inner wall of a receiving recess for receiving an end of said pipe, the housing comprising at least one through hole extending from a first aperture in an external surface of the housing through to a second aperture in the inner wall of the receiving recess;

and characterized in that the coupling has at least one fixing element, the fixing element being adapted to slidingly mate with the through hole in the housing to give a mated configuration, and when in the mated configuration, an engagement part of the fixing element is adapted to project through the second aperture to lockingly engage with said outer surface of said pipe, and wherein the through hole is provided with a locking means adapted to be configured in an open configuration, in which the fixing element can be slidingly mated with or removed from the through hole, through the first aperture, and a locked configuration, in which the locking means holds the fixing element in the mated configuration in the through hole.

By pipe is meant a liquid or fluid conduit. The pipe will typically be of uniform cross-sectional shape normal to a long axis. The cross-sectional shape may be any suitable shape, but typically will be circular such that the pipe may be tubular in shape. For a tubular pipe, the fixing elements are preferably moveable between a radially outward position with respect to the tubular wall and a radially inward position with respect to the tubular wall in which the fixing elements engage the pipe.

By perimeter of the pipe is meant the outer surface of the cross section of the pipe normal to its long axis.

Because the locking means and the fixing means may be made of different materials, the materials used may be selected to be suitable for the purpose of each. For instance the locking means may be of a hard material resistant to corrosion from weather, whereas the fixing means may be of a different material which is more resistant to corrosion by the fluid in the pipe, but less suitable for making a rigid locking means.

Because the fixing means can be put in place or removed through the first aperture in the external wall of the housing of the coupling, this means that the pipe and coupling can be assembled easily, allowing the fixing means to be put in place after assembly.

Suitably, in a first embodiment of the coupling according to the first aspect of the invention, the through hole comprises a first shaft extending from the first aperture to a junction with a second shaft which extends to the second aperture, wherein the second aperture has a smaller cross section than the first aperture whereby a step is formed at the junction and wherein the fixing element comprises a head and an arm, the head adapted to slidingly fit into the first shaft and the arm adapted to slidingly fit into the second shaft, whereby in the mated configuration, the head abuts the step and the arm projects through the second aperture as the engagement part to lockingly engage with said outer surface of said pipe.

By shaft, in this context, is meant a tunnel or hole.

Preferably, the coupling of the first embodiment comprises a first seal between the step and the head of the fixing means. The seal may be any suitable fluid-tight seal such as a copper seal or a rubber or fluoroelastomer seal or gasket, e.g. a Viton™ seal.

Suitably, the first and second shafts of the through hole are coaxial cylindrical boreholes. In this case, the fixing means will be in the form of a cylindrical shaft with a concentric cylindrical head.

In a second embodiment of the first aspect of the invention, the through hole comprises a tapered shaft narrowing in cross sectional area in a direction from the first aperture towards the second aperture and wherein the fixing element is a tapered peg adapted to mate with the tapered shaft. Suitably, the tapered shaft and the tapered peg have a truncated conical (i.e. frusto-conical) shape.

In a third embodiment of the first aspect of the invention, the fixing element has a substantially spherical shape.

The following features are all applicable to the first, second and third embodiments of the first aspect of the invention.

Suitably, the fixing element is of a first material and the locking means is of a second material. The first and second materials may thus be of different materials. Preferably, the first material is more deformable than the second material of the locking element (e.g. having a lower yield stress). This provides the advantage that any over-tightening of the locking means, pressing the fixing means into the pipe, can be compensated by deformation of the fixing means, leading to lower risk of fracture or damage of the pipe and risk of fluid leakage.

Suitably, there is a threaded engagement between the locking means and the housing through the hole at the first aperture.

For instance, the locking means may be a grub screw adapted to engage with a tapped portion of the through hole to give the locked configuration, and removed from the through hole to give the open configuration. Any suitable screw fastener could be used, such as a bolt or screw, where the bottom of the bolt or screw pushes against the mated fixing element in the locked configuration to hold the fixing element in place, engaged with the pipe.

Preferably, the fixing element has a connection means adapted to engage with a removal tool whereby the fixing element may be removed from the through hole, out of the first aperture, when the locking means is in the open configuration. The connection means may, for instance, be a tapped opening and the removal tool comprise a threaded rod adapted to engage with the tapped opening. This allows the removal tool to be screwed into the tapped hole when the fixing element is in the mated position, with the locking means in the open configuration. The removal tool can then be used to withdraw the fixing element from the through hole out of the first aperture in the external wall of the housing of the coupling. Other methods could be used to lock the locking means within the coupling end housing, which are well known in the art of fixings.

Suitably, the coupling of the invention further comprises a second seal between its inner wall and the outer surface of the pipe. This second seal is preferably located at a position between the fixing element and an open end of the receiving recess, so as to prevent leakage of any fluid that may arise from the vicinity of the fixing element leaking out of the coupling as a whole.

Suitably, the second seal is a seal mounted within a recess formed around the inner wall of the receiving recess. The seal may be, for instance, a rubber or fluoroelastomer o-ring or gasket.

The fixing element may simply push against the outer surface of the pipe, or may be provided with a serrated or roughened end to better grip the pipe's outer surface when pushed against it in the mated configuration. Preferably, the fixing element is adapted to engage with the pipe by extending at least partly into one or more recesses formed in said outer surface of said pipe. In other words, when in the mated configuration, a portion of the fixing element extends into the receiving recess so that it can fit into an indentation or hole or other recess formed in the outer surface of the pipe.

Preferably, the coupling of the invention has an inner wall with an abutment adapted to engage with an end of the pipe. This allows the pipe to be firmly pushed into the receiving recess of the coupling until it rests against the abutment, to aid with alignment. The abutment may be an annular shoulder extending from the inner wall into the receiving recess.

Suitably, the coupling of the invention has an inner wall in the shape of a right cylinder whereby it is adapted to engage with a cylindrical pipe. Preferably, the coupling comprises a plurality of through holes, with corresponding fixing elements and locking means arranged substantially uniformly around a perimeter of the external surface of the housing. These may be arranged in a symmetrical manner or evenly spaced around the perimeter of the housing to minimize stresses in the housing and the gripped pipe.

Suitably, the coupling of the invention may comprise two coupling ends and a conduit between the coupling ends, so that it is suitable for joining two sections of pipe together in fluid-tight connection. An accessory, such as a valve, tap or third coupling end may be located between the two coupling ends.

A second aspect of the invention provides a method of fixing a pipe in a coupling according to the first aspect of the invention, comprising the sequential steps of:

a) fitting an end of the pipe within the receiving recess of the coupling,

b) with the locking means in the open configuration, sliding the fixing element through the first aperture into the through hole to mate therewith and to engage an outer surface of the pipe,

c) configuring the locking means into the locked configuration whereby the fixing element is held in the mated configuration engaging the pipe.

The method according may comprise the further step, after step (a) and before step (b) of:

drilling a first hole in the pipe by directing a drilling tool through the through hole in the coupling end housing with the locking means in the open configuration, whereby the fixing element engages with the first hole in the pipe in steps (b) and (c).

Cold drilling, cooled by running water, can be used to drill holes in the pipe, so as to prevent the generation of sparks.

Preferably, the first hole suitably does not extend through the outer surface of the pipe to an inner surface of the pipe. This still allows the pipe to be held in place by the fixing means, when in the mated configuration, but prevents risk of leakage of fluid from the pipe.

However, the invention also includes the possibility that the first hole extends through the outer surface of the pipe to an inner surface of the pipe. This provides a highly secure grip as the fixing element can then extend through the entire wall of the pipe.

The coupling and method according to the present invention are simple and easy to apply to a tubular conduit or pipe, without requiring a skilled workforce of welders and only simple drilling tools are required. The locking means can be engaged from the outside of the coupling end by an external tool. The external tool is engageable with the locking means to fix them in a position in which they bring the fixing elements to engage a pipe or to unfix them from such a position. The coupling is relatively cheap to make as only low precision manufacturing tolerances are required and the coupling is cheap to install due to low labour cost, especially where the tubular elements are part of a pipeline of large diameter, for example for transporting gas or oil. The coupling is safe to fit, as it does not require welding. The sealing arrangement provides a good seal for the coupling end and the tubular conduit fitted within it and so is not susceptible to leaks. The fixing element may engage such a tubular conduit by extending at least partly through a corresponding hole formed in a wall of a pipe. This engagement of the fixing elements with the through holes in the housing and with holes in the pipe ensures that the pipe fitted within the coupling is secured against rotation. Also, the fitting of the coupling end to the tubular conduit does not obstruct the flow of fluid within the conduit. In addition, the tubular conduits can easily be removed from the coupling, by simple removal of the locking elements and withdrawal of the fixing elements through the exterior of the housing. This allows for easy maintenance or repair. The present invention has particular advantage over the prior art for connecting pipes having a diameter over 5 cms, and especially for pipes having a diameter of around 1 m and above.

Specific embodiments of the present invention will now be described, by way of example only, with reference to the accompanying drawings in which:

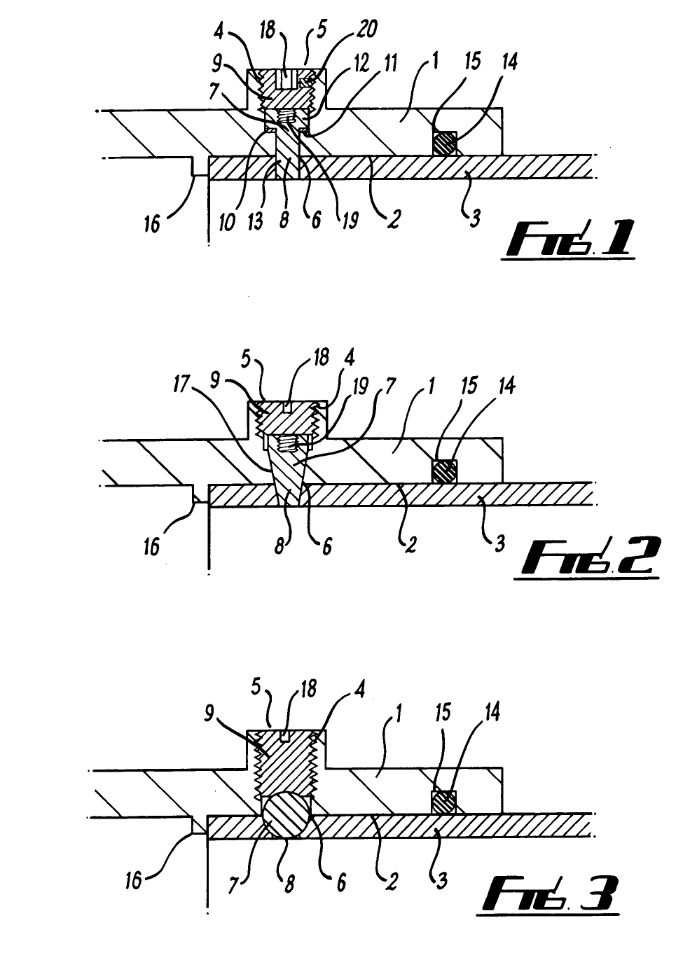

FIG. 1 shows a cross sectional view of a pipe coupling according to the first embodiment of the first aspect of the invention,

FIG. 2 shows a cross sectional view of part of a pipe coupling according to the second embodiment of the first aspect of the invention,

FIG. 3 shows a cross sectional view of part of a pipe coupling according to the third embodiment of the first aspect of the invention.

Turning now to FIG. 1, this shows a coupling having a housing 1 having a receiving recess with a tubular inner wall 2 fitting a tubular pipe 3. A through hole 4 extends from a first aperture 5 in a raised section of the external surface of the housing 1 through to a second aperture 6 in the inner wall 2 of the receiving recess.

The through hole has a first cylindrical shaft extending from the first aperture 5 to a junction 10 with a second shaft that extends to the second aperture 6 in the inner wall 2. The second aperture 6 and its corresponding shaft have a smaller diameter than the first aperture 5 and its corresponding shaft.

A fixing element 7, having a head 12 and an arm 13, is located in the through hole in a mated configuration with the through hole. A seal in the form of a washer 11 is seated on the step 10 between the head 12 and the fixing element 7. An engagement part 8 of the arm 13 extends into an opening in the pipe 3 to lock the pipe in place in the receiving recess. A threaded hole 19 is provided in the head 12 of the fixing element 7.

A locking means in the form of a grub screw 9 is located in a tapped section of the through hole 4 where it presses against the head 12 of the fixing element 7 to hold it in the mated configuration. The grub screw 9 has an aperture 18 in it in the form of a hexagonal hole to allow it to engage with a hexagonal key for tightening or slackening. The grub screw 9 also has a nylon insert 20 to hinder vibration-induced loosening of the grub-screw 9 in use.

The end of the pipe 3 fits snugly against an abutment 16 on the inner wall 2 of the receiving recess. An o-ring seal 14 runs around the inner wall in a groove 15 to provide a fluid tight seal between the inner wall 2 and the pipe 3.

In use, the coupling is prepared initially by removing the grub screw 9 and the fixing element 7 from the through hole 5. The pipe 3 is slid into the receiving recess of the housing 1 past the o-ring 14 until its end locates against the abutment 16.

A drill is then used to drill a hole in the pipe 3 using the shaft connected to the second aperture 6 as a guide. The drill is than removed and the fixing element 7 slid into the through hole, with the washer 11 where it mates with the through hole and the engagement part 8 of the arm 13 fits into the drilled hole in the pipe 3. The grub screw 9 is then tightened into the through hole 4 through the first aperture 5 to lock the fixing element in place by tightening the grub screw 9 against the head 12 of the fixing element 7.

If it is necessary to disconnect the pipe from the coupling, the grub screw 9 is unfastened and the fixing element withdrawn using any suitable bolt which can be screwed into the tapped hole 19 and used to extract the fixing element 7 from the through hole 5. The pipe 3 can then be pulled out of the housing 1 past the o-ring seal 14.

Turning now to FIG. 2, this shows a coupling having a housing 1 having a receiving recess with a tubular inner wall 2 fitting a tubular pipe 3. A through hole 4 extends from a first aperture 5 in a raised section of the external surface of the housing 1 through to a second aperture 6 in the inner wall 2 of the receiving recess.

The through hole 5 has a portion 17 in the form of a tapered frusto-conical shaped shaft, which narrows in diameter towards the second aperture 6.

A fixing element 7, is in the shape of a frusto-conical peg and mates with the tapered shaft 17 to give in a mated configuration.

An engagement part 8 of the frusto-conical fixing element 7 extends into an opening in the pipe 3 to lock the pipe 3 in place in the receiving recess. A threaded hole 19 is provided in the head 12 of the fixing element 7.

A locking means in the form of a grub screw 9 is located in a tapped section of the through hole 4 where it presses against the widest part of the frusto-conical fixing element 7 to hold it in the mated configuration. The grub screw 9 has an aperture 18 in the form of a slot to allow for tightening or slackening by a screwdriver.

The end of the pipe 3 fits snugly against an abutment 16 on the inner wall 2 of the receiving recess. An o-ring seal 14 runs around the inner wall in a groove 15 to provide a fluid tight seal between the inner wall 2 and the pipe 3.

In use, the coupling is prepared initially by removing the grub screw 9 and the fixing element 7 from the through hole 5. The pipe 3 is slid into the receiving recess of the housing 1 past the o-ring 14 until its end locates against the abutment 16.

A tapered mill is then used to drill a tapered hole in the pipe 3 using the shaft connected to the second aperture 6 as a guide. The drill is than removed and the fixing element 7 slid into the through hole, and the engagement part 8 of the fixing element 7 fits into the drilled, tapered hole in the pipe 3. The grub screw 9 is then tightened into the through hole 4 through the first aperture 5 to lock the fixing element in place by tightening the grub screw 9 against the broadest end of the tapered peg fixing element 7.

If it is necessary to disconnect the pipe from the coupling, the grub screw 9 is unfastened and the fixing element 7 withdrawn using any suitable bolt which can be screwed into the tapped hole 19 and used to extract the fixing element 7 from the through hole 5. The pipe 3 can then be pulled out of the housing 1 past the o-ring seal 14.

Turning now to FIG. 3, this shows a coupling having a housing 1 having a receiving recess with a tubular inner wall 2 fitting a tubular pipe 3. A through hole 4 extends from a first aperture 5 in a raised section of the external surface of the housing 1 through to a second aperture 6 in the inner wall 2 of the receiving recess.

The through hole 5 is substantially uniform in diameter between the first aperture 5 and the second aperture 6, but is tapped with a thread in the vicinity of the first aperture 5.

A fixing element 7 is in the shape of a sphere and sits snugly in the through hole 4 to give in a mated configuration.

An engagement part 8 of the spherical fixing element 7 (which can be any part of the spherical fixing element 7) extends into an opening in the pipe 3, the diameter of the opening being smaller than the diameter of the spherical fixing element 7, in order to lock the pipe in place in the receiving recess.

A locking means in the form of a grub screw 9 is located in the tapped section of the through hole 4 where it presses against the spherical fixing element 7 to hold it in the mated configuration. The grub screw 9 has an aperture 18 in the form of a slot to allow for tightening or slackening by a screwdriver.

The end of the pipe 3 fits snugly against an abutment 16 on the inner wall 2 of the receiving recess. An o-ring seal 14 runs around the inner wall in a groove 15 to provide a fluid tight seal between the inner wall 2 and the pipe 3.

In use, the coupling is prepared initially by removing the grub screw 9 and the fixing element 7 from the through hole 5. The pipe 3 is slid into the receiving recess of the housing 1 past the o-ring 14 until its end locates against the abutment 16.

A tapered mill or a drill is then used to drill a tapered hole or a hole in the pipe 3 using the shaft connected to the second aperture 6 as a guide. The drilled or milled hole is of a diameter such that the spherical fixing element 7 cannot pass through it. The drill or mill is than removed and the fixing element 7 slid into the through hole, and the engagement part 8 of the fixing element 7 fits into the hole formed in the pipe 3. The grub screw 9 is then tightened into the through hole 4 through the first aperture 5 to lock the fixing element 7 in place by tightening the grub screw 9 against the spherical fixing element 7.

If it is necessary to disconnect the pipe from the coupling, the grub screw 9 is unfastened and the fixing element 7 withdrawn using any suitable bolt which can be screwed into the tapped hole 19 and used to extract the fixing element 7 from the through hole 5. The pipe 3 can then be pulled out of the housing 1 past the o-ring seal 14.

For each of the above embodiments, the housing and grub screws are typically formed from steel, whereas the fixing elements are of a more malleable material such as copper or an alloy.

It will be appreciated that numerous modifications to the above described embodiment may be made without departing from the scope of the invention as defined in the appended claims. For example, the coupling might be supplied with the through hole 5 blind or provided with a small pilot hole at the position of the second aperture 6, with this aperture being formed at the same time that the pipe is drilled. For example, the coupling may be provided with a plurality of through holes, fixing elements and grub screws distributed around the external surface of the housing of the coupling. For example, the holes drilled or milled in the pipe 3 may only partially extend into the pipe wall, and not pierce the pipe wall.

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

What is claimed is:

1. A coupling having at least one coupling end for connection to a pipe having an outer surface, wherein the coupling end comprises:
a housing defining an inner wall of a receiving recess for receiving an end of said pipe, the housing comprising at least one through hole extending from a first aperture in an external surface of the housing through to a second aperture in the inner wall of the receiving recess;
and characterized in that the coupling has at least one fixing element, the fixing element being adapted to slidingly mate with the through hole in the housing to give a mated configuration, and when in the mated configuration, an engagement part of the fixing element is adapted to project through the second aperture to lockingly engage with said outer surface of said pipe,
and wherein the through hole is provided with a locking means adapted to be configured in an open configuration, in which the fixing element can be slidingly mated with or removed from the through hole through the first aperture, and a locked configuration, in which the locking means holds the fixing element in the mated configuration in the through hole.

2. The coupling of claim 1 wherein the through hole comprises a first shaft extending from the first aperture to a junction with a second shaft which extends to the second aperture, wherein the second aperture has a smaller cross section than the first aperture whereby a step is formed at the junction and wherein the fixing element comprises a head and an arm, the head adapted to slidingly fit into the first shaft and the arm adapted to slidingly fit into the second shaft, whereby in the mated configuration, the head abuts the step and the arm projects through the second aperture as the engagement part to lockingly engage with said outer surface of said pipe.

3. The coupling of claim 2 comprising a first seal between the step and the head of the fixing means.

4. The coupling of claim 2 or claim 3 wherein the first and second shafts are coaxial cylindrical boreholes.

5. The coupling of claim 1 wherein the through hole comprises a tapered shaft narrowing in cross sectional area in a direction from the first aperture towards the second aperture and wherein the fixing element is a tapered peg adapted to mate with the tapered shaft.

6. The coupling of claim 5 wherein the tapered shaft and the tapered peg have a truncated conical shape.

7. The coupling according of claim 1 wherein the fixing element has a substantially spherical shape.

8. The coupling of claim 1 wherein the fixing element is of a first material and the locking means is of a second material, preferably wherein the first material is more deformable than the second material.

9. The coupling of claim 1 wherein there is a threaded engagement between the locking means and the housing through the hole at the first aperture.

10. The coupling of claim 9 wherein the locking means is a grub screw adapted to engage with a tapped portion of the through hole to give the locked configuration, and removed from the through hole to give the open configuration.

11. The coupling of claim 1 wherein the fixing element has a connection means adapted to engage with a removal tool whereby the fixing element may be removed from the through hole, out of the first aperture, when the locking means is in the open configuration.

12. The coupling of claim 11 wherein the connection means is a tapped opening and said removal tool comprises a threaded rod adapted to engage with the tapped opening.

13. The coupling of claim 1 comprising a second seal between the inner wall and said outer surface of said pipe.

14. The coupling according of claim 13 wherein the second seal is located at a position between the fixing element and an open end of the receiving recess.

15. The coupling of claim 13 wherein the second seal is a seal mounted within a recess formed around the inner wall of the receiving recess.

16. The coupling of claim 1 wherein the fixing element is adapted to engage with said pipe by extending at least partly into one or more recesses formed in said outer surface of said pipe.

17. The coupling of claim 1 wherein the inner wall has an abutment adapted to engage with an end of said pipe.

18. The coupling of claim wherein the inner wall has the shape of a right cylinder whereby it is adapted to engage with a cylindrical pipe.

19. The coupling of claim 1 comprising a plurality of through holes, with corresponding fixing elements and locking means arranged substantially uniformly around a perimeter of the external surface of the housing.

20. The coupling of claim 1 comprising two coupling ends and a conduit between the coupling ends.

21. A method of fixing a pipe in a coupling according to claim 1, comprising the sequential steps of:
a) fitting an end of the pipe within the receiving recess of the coupling,
b) with the locking means in the open configuration, sliding the fixing element through the first aperture into the through hole to mate therewith and to engage an outer surface of the pipe,
c) configuring the locking means into the locked configuration whereby the fixing element is held in the mated configuration engaging the pipe.

22. The method according to claim 21 further comprising the step, after step (a) and before step (b) of:
drilling a first hole in the pipe by directing a drilling tool through the through hole in the coupling end housing with the locking means in the open configuration, whereby the fixing element engages with the first hole in the pipe in steps (b) and (c).

23. The method according to claim 22 wherein the first hole does not extend through the outer surface of the pipe to an inner surface of the pipe.

24. The method according to claim 22 wherein the first hole extends through the outer surface of the pipe to an inner surface of the pipe.

25. (canceled)
